(19) United States
(12) Patent Application Publication
(10) Pub. No.: US 2012/0324751 A1
(43) Pub. Date: Dec. 27, 2012

(54) FISH MEASUREMENT DEVICE

(75) Inventor: Kevin Wakeman, Algonquin, IL (US)

(73) Assignee: Kevin Wakeman, Algonquin, IL (US)

(21) Appl. No.: 13/166,047

(22) Filed: Jun. 22, 2011

(51) Int. Cl. G01B 3/10

(52) U.S. Cl. 33/759

(57) ABSTRACT

A fish measurement device is disclosed formed as an elongated rectangular substrate with ruler type markings for measuring the length of a fish. An important aspect of the invention is that the substrate is formed from a flexible resilient material that allows the device to folded or rolled up into a relatively compact volume. Another important aspect of the invention is that it includes one or more bumps that project upwardly from the plane of the elongated substrate that enable the user to hold the fish head firmly against, yet do not prevent the fish measurement device from being rolled or folded. The ability to hold a fish against a bump enables relatively accurate measurements to be taken.

### BACKGROUND OF THE INVENTION

1. Field of the Invention

The present invention relates to a fish measurement device for measuring the length of a live fish and more particularly to a fish measurement device formed from an elongated flexible substrate that can be rolled up or folded into a relatively compact volume which includes ruled markings and one or more bumps for enabling the user to hold a live fish firmly in place.

2. Description of the Prior Art

Various fish measurement devices are known in the art. Examples of such fish measurement devices are disclosed in: U.S. Pat. Nos. 5,097,617; 5,148,607; 5,339,532; 5,526,575; 6,594,939; 6,765,155; 6,959,499; 5,637,838; 6,415,521 and Japanese Patent Appl. No. JP 2004 132943. Most of these patents, published patent applications and publications disclose a fish measurement device formed from a rigid substrate that includes ruled markings used to measure the length of a fish.

Such fish measurement devices are normally transported to and from home to a fishing boat or other fishing venue. Rigid fish measurement devices are known to be three feet long or longer and thus take up a fair amount of space during transport and are awkward and cumbersome to handle. As such, various attempts have been made to resolve this problem, For example, U.S. Pat. No. 7,191,536 discloses a fish measurement device formed as a holster type device with one side of the holster partially open in order to facilitate sliding the fish fully into the holster. An inner surface of the holster includes markings that are viewable from the partially open side when the fish is seated in the holster. Unfortunately, the holster extensively limits the size of fish that can be measured.

Other attempts to develop a fish measurement device to overcome the problems associated with rigid fish measurement devices also have shortfalls. In particular, fish measurement devices formed from a flexible substrate have been developed. One problem with such fish measurement devices is that they do not include bumps or rigid vertical surfaces that can be used to hold a fish firmly against to get an accurate measurement of the fish.

U.S. Pat. Nos. 4,565,012; 7,665,220 and US Patent Application Publication No. 2008/034600 all disclose fish measurement devices with a flexible substrate. In particular, the '012 patent discloses a flexible marking and measuring device which can be folded or rolled formed a plurality of preferably elongated, rectangular, flat, thin members parallel one with another and sequentially flexibly connected one to another whereby the marking instrument may be folded or rolled to fit in a pocket or tool chest and/or bent or flexed to follow substantially any surface. One edge can be used as ruler and provide inch and/or metric indicia. The '220 patent discloses a fish measurement device formed from a piece of cloth with measurement markings amenable to being attached to a user's belt. No bumps are provided making the task of obtaining an accurate measurement cumbersome. Since such fish measurement devices are used to measure the length of live fish, the fish will be flipping around making it difficult if not impossible to line the fish up and hold the fish in order to line the fish up with the ruled markings on the substrate. Moreover, the fish measurement device disclosed in the '220 patent is made from cloth and therefore would absorb the fish odor and thus require frequent machine washing. Thus, there is a need for a fish measurement device that is flexible and can be folded or rolled into a smaller volume for transport and yet includes bumps for enabling accurate fish measurements and does not require machine washing.

### SUMMARY OF THE INVENTION

Briefly, the present invention relates to a fish measurement device formed as an elongated rectangular substrate with ruled markings for measuring the length of a fish. An important aspect of the invention is that the substrate is formed from a flexible resilient material that allows the device to folded or rolled up into a relatively compact volume. Another important aspect of the invention is that it includes one or more bumps that project upwardly from the plane of the elongated substrate that enable the user to hold the fish head firmly against, yet do not prevent the fish measurement device from being rolled or folded. The ability to hold a fish against a bump enables relatively accurate measurements to be taken.

### DESCRIPTION OF THE DRAWING

These and other advantages of the present invention will be readily understood with reference to the following specification and attached drawing wherein:

FIG. 1 is a partial top view of a fish measurement device in accordance with the present invention shown with a fish against a head bump.

FIG. 2 is an isometric view of one embodiment of the present invention, shown with a head bump, two side bumps and attached band for securing the fish measurement device when it is rolled up for transport and storage.

FIG. 3 is similar to FIG. 2 but illustrating a head bump and a single side bump.

FIG. 4 is similar to FIG. 2 but illustrating a head bump and no side bumps.

FIG. 5 is a plan view of the fish measurement device illustrated in FIG. 2.

FIG. 6 is side elevational view of the fish measurement device illustrated in FIG. 2.

FIG. 7 is end elevational view of the fish measurement device illustrated in FIG. 2.

FIG. 8 is an isometric view illustrating the fish measurement device illustrated in FIG. 2 in a rolled up position and secured with the band that is attached to the fish measurement device.

FIG. 9 is similar to FIG. 8 but secured with straps and Velcro type fasteners.

### DETAILED DESCRIPTION

The present invention relates to a fish measurement device, commonly known as a bump board, formed as an elongated rectangular substrate with ruled markings, i.e. ruler type markings, for measuring the length of a fish. An important aspect of the invention is that the substrate is formed from a flexible resilient material that allows the fish measurement device to folded or rolled up into a relatively compact volume. Another important aspect of the invention is that it includes one or more bumps that project upwardly from the plane of the elongated substrate that enable the user to hold the fish head firmly against, yet do not prevent the fish measurement device from being rolled or folded. For example, the fish measurement device may include a rigid head bump at the front end of the device that projects upwardly from the plane of the substrate on a head end of the substrate to enable the user to hold the fish head firmly against the head bump. The device may also include or alternatively include one or more side bumps that also project upwardly from the plane of the substrate. The side bumps are disposed along the edges of the substrate to enable the user to hold the fish body firmly against one of the side bumps. The ability to hold a fish against a bump enables relatively accurate measurements to be taken.

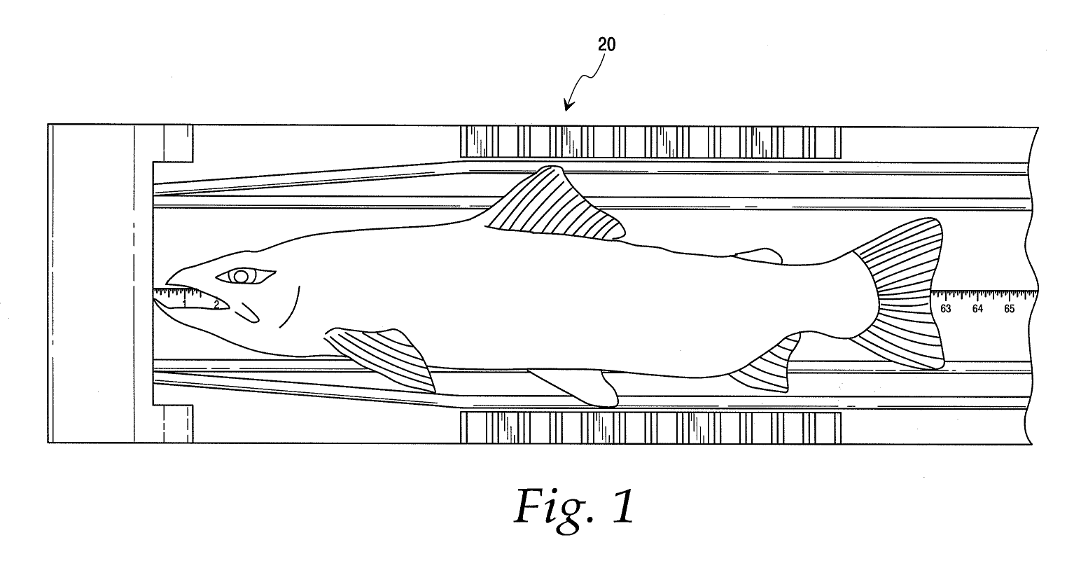

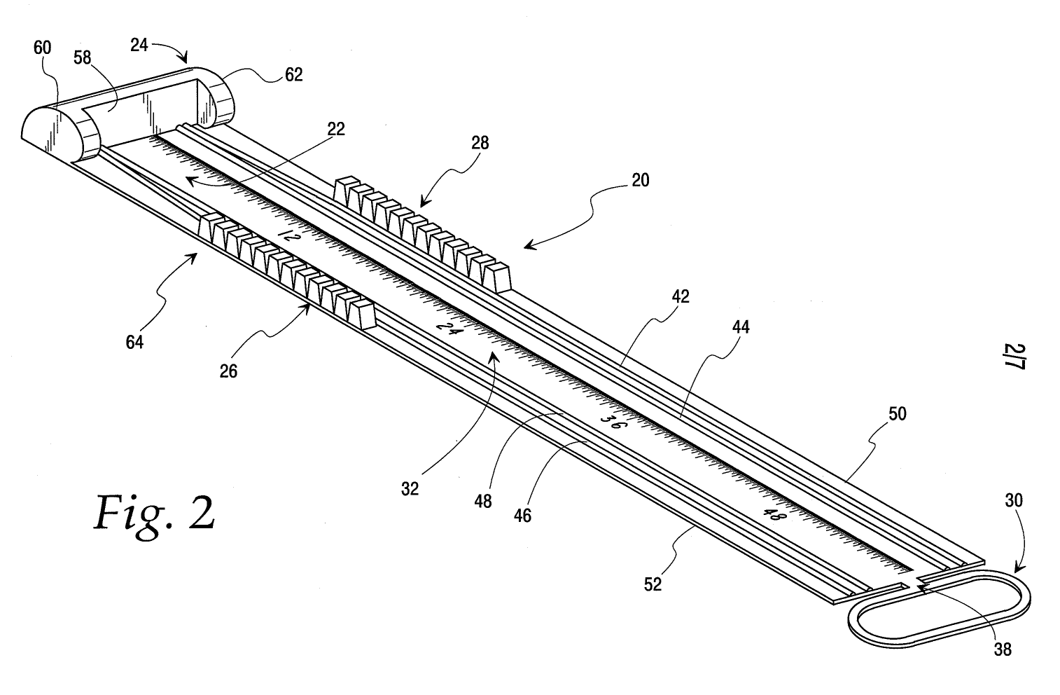

Referring to FIG. 2, the fish measurement device in accordance with the present invention is shown and generally identified with the reference numeral 20. As shown in FIG. 1, the fish measurement device 20 is used to get a relatively accurate measurement of the length of a live fish. The fish measurement device 20 includes an elongated substrate 22, an optional head bump 24 and one or more optional side bumps 24 and 26, ruled markings, generally identified with the reference numeral 32, and an optional attached band 30.

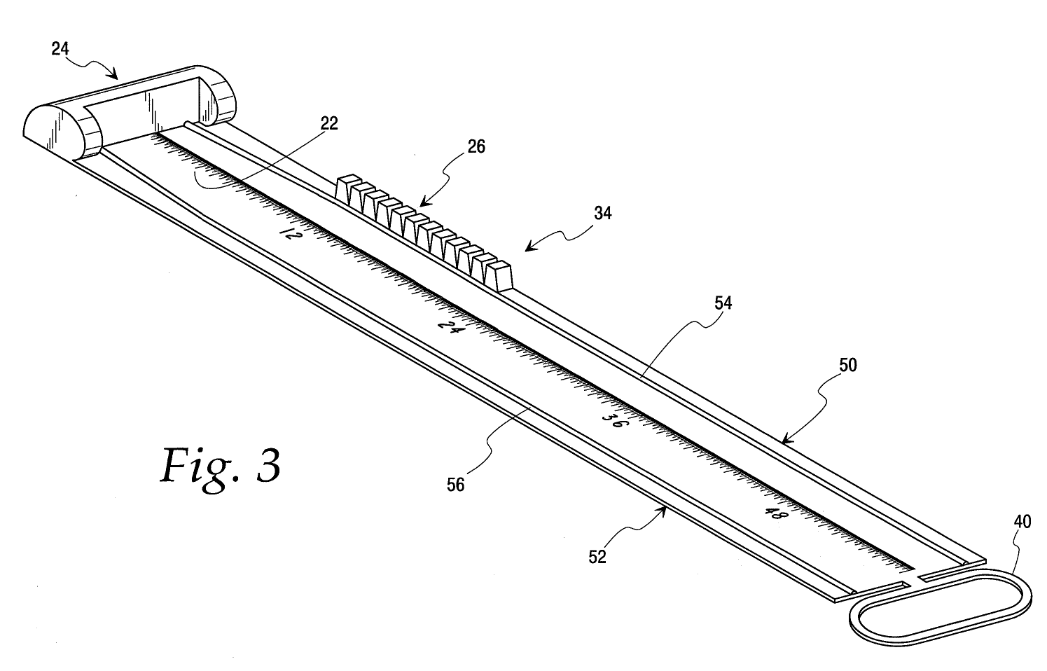

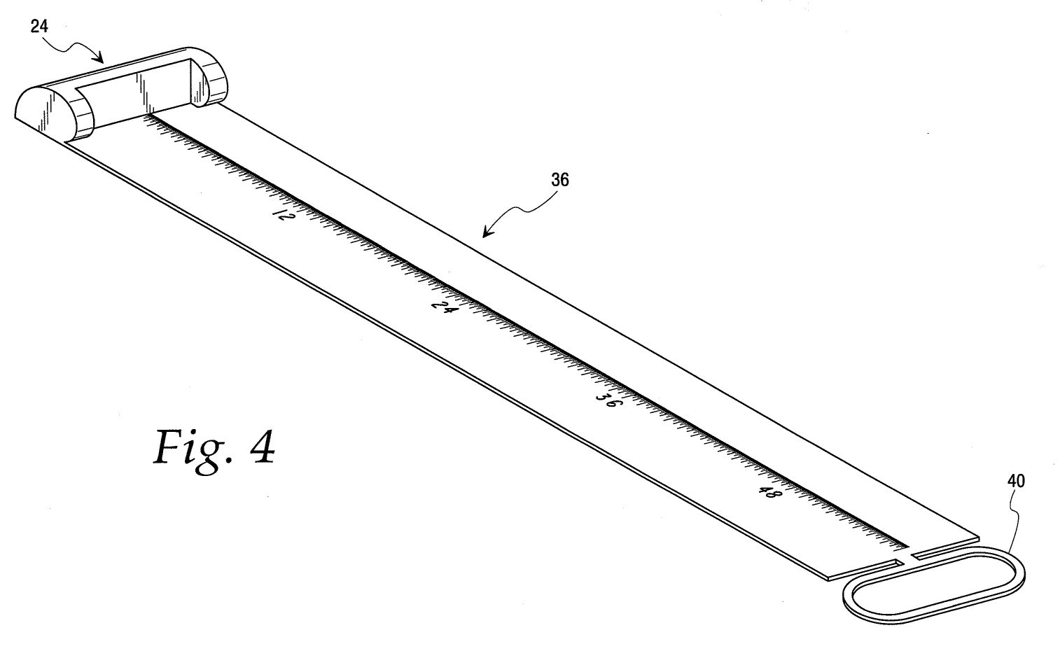

Various embodiments of the fish measurement device 20 are contemplated. As used herein, the same reference numbers are used to identify identical components in different embodiments. FIG. 2 illustrates an embodiment which includes a head bump 24 and two (2) side bumps 26 and 28. FIG. 3 illustrates an embodiment, generally identified with the reference numeral 34, which includes a head bump 24 and one side bump 26. FIG. 4 illustrates an embodiment, generally identified with the reference numeral 36, which includes a head bump 24 and no side bumps. Other embodiments (not shown) include fish measurement devices which do not include a head bump 24 and include one or two side bumps 26, 28. All of such embodiments are suitable for measuring the length of a fish, as generally illustrated in FIG. 1. With a live fish flapping around being out of the water, it is difficult to align a live fish with the ruled markings on known fish measurement devices that are flexible. The fish measurement devices 20, 34 and 36 in accordance with the present invention provide for flexibility and also provide at least one bump to enable a user to hold a live fish in a relatively secure position against the bump for the purpose of measuring the length of a live fish.

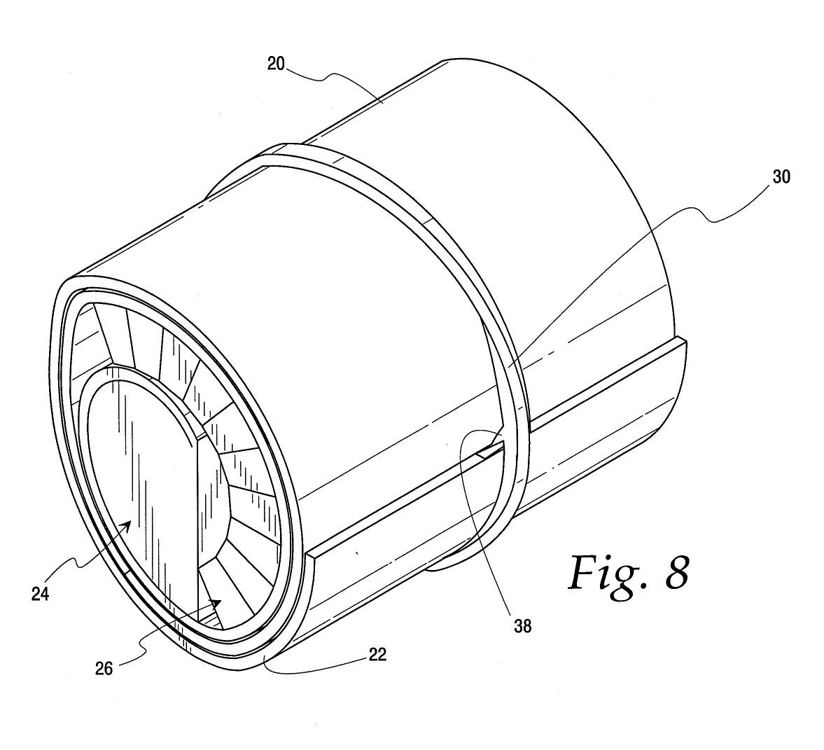

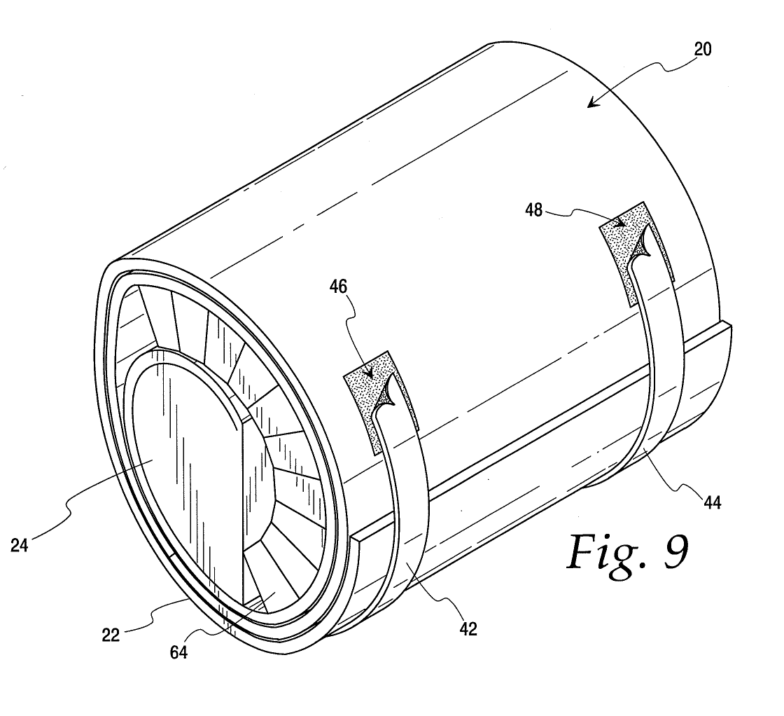

The fish measurement devices 20, 34 and 36, illustrated in FIGS. 2-4 respectively, can be folded (not shown) or rolled up, as generally shown in FIGS. 8 and 9. As shown in FIG. 8, the fish measurement device 20 is secured in a rolled up position with the band 30, which may be connected to the end of substrate 22 by way of a interconnecting link 38. A separate band 40, as generally shown in FIGS. 3-5 may also be used. FIG. 9 illustrates an alternate embodiment in which one or more straps 46, 48 for example, nylon straps, and one or more fastener systems 46, 48, for example, Velcro or other fastener systems, may be used to secure the fish measurement device 20 in a rolled up position, as shown.

Referring to FIGS. 2-4, various embodiments of the fish measurement devices 20, 34 and 36 are illustrated. As mentioned above, the fish measurement devices 20. 34 and 36 include an elongated substrate 22. In accordance with an important aspect of the invention, the substrate 22 is formed from a flexible material, such as elastomeric material, having a thickness of ¼ inch or more with several or all of the following properties:
Waterproof
UV Resistant
Stain Resistant
Floats in Water
Stable in temperature range 25° F.-140° F.
Flexible but Resilient
Unbreakable
Optionally white or light colored.

Based on the properties mentioned above, various types of synthetic rubber, for example, are well suited for use in applications as the fish measurement devices 20, 34 and 36 in accordance with the present invention. Synthetic rubber is an artificial elastomer material with the material property that it can withstand relatively more elastic deformation under stress than most materials and still return to its previous size without permanent deformation, thus providing flexibility and resiliency. Silicone rubber is one type of synthetic rubber that may be used in a fish measurement device application. Not only is silicone rubber flexible and resilient, it is relatively inert and will not absorb any residue from the fish. As such, silicone rubber enables the fish measurement devices 20, 34 and 36 to be quickly and easily cleaned by simply dipping the fish measurement devices 20, 34 and 36 in the water before being folded or rolled up, as illustrated in FIGS. 8 and 9. Another useful property of silicone rubber is that it can be injection molded which enables the fish measurement devices 20, 34 and 36 to be integrally formed as a unitary device and optionally formed as a hollow device to enable the device to float in water. In this way, if the fish measurement device gets accidentally dropped in the water, it can easily be retrieved. Other materials that have similar properties, such as synthetic rubber, are also suitable.

The fish measurement devices 20, 34 and 36 can be made in various widths and lengths depending on the fishing application. For example, the fish measurement devices 20, 34 and 36 can be formed to be about 65 inches long and about 12 wide. Such a configuration would ideal for perch and pike which run up to about 30 inches in length and Musky which can run up to 60 inches in length. Shorter lengths are also contemplated.

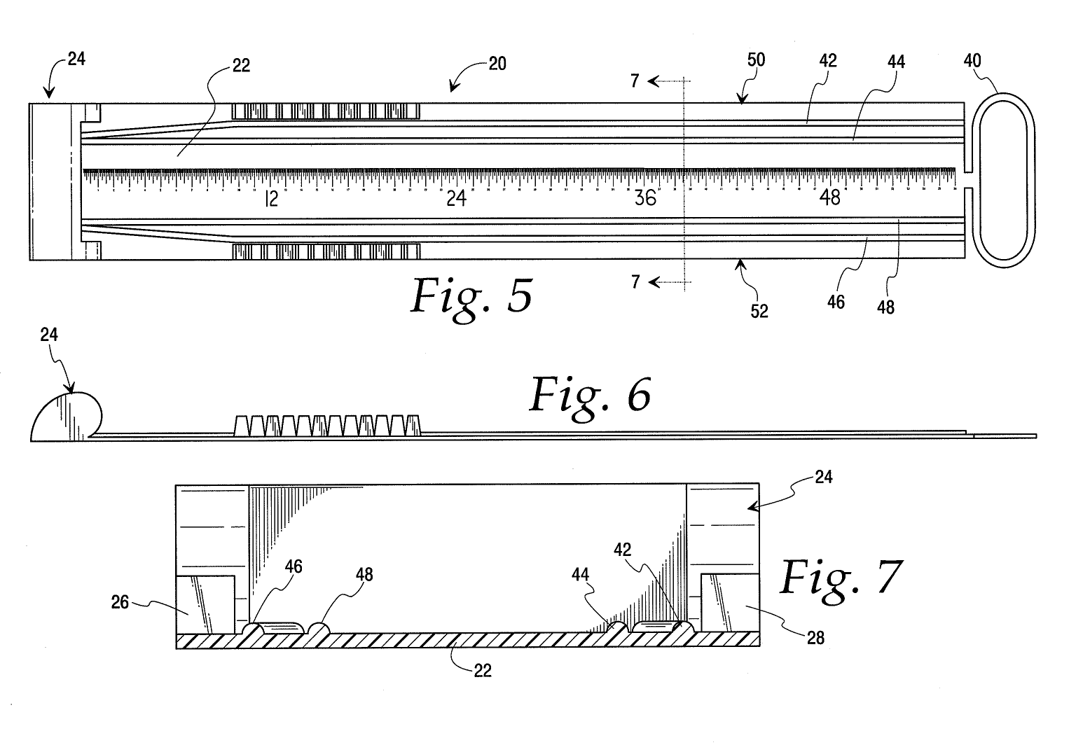

As shown in FIGS. 2, 3 and 5, the fish measurement devices 20 and 34 may be formed with runners adjacent to opposite edges of the substrate 22 to along its length to prevent residue or slime from the fish from getting into the boat. The runners generally confine the residue or slime from the fish between the runners adjacent the opposite edges of the substrate 22. More particularly, as best shown in FIGS. 5 and 7, the fish measurement device 20 illustrates an embodiment with two pairs of runners 42, 44 and 46, 48 adjacent opposing edges 50 and 52 of the substrate 22. As shown, the runners 42, 44 and 46, 48 in each pair of runners are spaced apart from each other and from the edge of the substrate 22 and start at the head bump 24 and generally run the entire length of the substrate 22 and generally parallel to it. The runners 42, 44 and 46, 48 may be formed to diverge and come together at the head bump end and formed to be generally parallel at the opposing end.

FIGS. 3 and 4 illustrate alternate embodiments. Turning first to FIG. 3, the fish measurement device 34 includes a single runner 54 and 56 adjacent each edge 50 and 52. The runners 54 and 56 start at the head bump 24 and run to the opposing end of the substrate generally parallel to the edges 50 and 52. FIG. 4 illustrates another embodiment of the invention that does not include runners on the substrate 22.

As mentioned above, the fish measurement device includes at least one bump; for example, a head bump 24 or one or more side bumps 26 and 28. Various embodiments of the head bump 24 and side bumps 26, 28 are contemplated. It is only necessary that the head bump 24 and side bumps 26, 28 provide a stable secure surface that is generally perpendicular to the substrate 22 that enables a user to firmly fold a fish against it.

An exemplary head bump is illustrated in FIGS. 2-7. The head bump 24 may be formed as a solid member which serves to weigh down the device on one end when rolled out and not in use. Referring to FIG. 2, the head bump 24 includes a bearing surface 58 for enabling a head end of a live fish to be firmly held against it. The bearing surface 58 may be generally flat and generally perpendicular to the surface of the substrate 22. Disposed on opposing sides of the bearing surface 58 are arcuate portions 60 and 62. The width of the arcuate portions 60 and 62 is sized to be received on the substrate 22 between the outside runners 42 and 46 and the edges 50 and 52, respectively, of the substrate 22. The arcuate portions 60 and 62 allow for a relatively compact profile when the fish measurement device 20 is rolled up, as generally shown in FIGS. 8 and 9.

Other configurations of the head bump 24 are contemplated. For example, the head bump 24 may be formed with a triangular, square or rectangular configurations (not shown). In all of such configurations including the configuration illustrated in FIGS. 2-7, the height of the head bump 24 is a matter of choice and may be around four (4) inches or more. Similarly, the length of the of the head bump 24 is a matter of choice and may be around four (4) inches or more.

An exemplary embodiment of the side bumps 26 and 28 is illustrated in FIGS. 2 and 3. In this embodiment, the side bumps 26 and 28 are formed from a plurality of teeth, generally identified with the reference numeral 64. Each tooth 64 is formed as an isosceles trapezoid. The teeth 64 are formed end to end between the outer most runner 44,46 (FIG. 2) or 54,56 (FIG. 3) and the edges 50 and 52 of the substrate 22. As shown in FIGS. 8 and 9, forming the teeth 64 as isosceles trapezoids provides for a relatively compact profile when the fish measurement device 20, 34 is rolled up. Other configurations of the side bumps are contemplated. For example, the side bumps 26 and 28 may be formed from a single rectangular block.

In order to facilitate roll up of the fish measurement device 20, 34, the leading edge of the side bumps 26 and 28 should be spaced away from the head bump 24 by a distance equal at least to the height of the head bump 24. This will allow the head bump 24 to seat on the substrate 22 next to the leading edge of the side bumps 26 and 28 when the fish measurement device 20, 34 is rolled up, as generally shown in FIGS. 8 and 9.

In order to enable measurement of a fish, ruled markings 32 are provided on the substrate 22. These ruled markings 32 are similar to the markings on a conventional ruler and may be provided in conventional British units, i.e. inches or metric units, i.e. centimeters. The ruled markings 32 may be provided by conventional printing methods, for example, using flexographic or ink jet printing systems.

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

1. A fish measurement device comprising:
a flexible substrate defining a head end and opposing edges, said substrate including ruled markings; and
at least one bump integrally formed with the flexible substrate that allows a live fish to be firmly held against it in order to measure the length of the fish.

2. The fish measurement device as recited in claim 1, wherein the flexible substrate is configured to float.

3. The fish measurement device as recited in claim 1, wherein the flexible substrate is hollow.

4. The fish measurement device as recited in claim 1, wherein said at least one bump is disposed adjacent said head end defining a head bump.

5. The fish measurement device as recited in claim 1, wherein said at least one bump is disposed adjacent said one of said opposing edges defining a side bump.

6. The fish measurement device as recited in claim 4, further including at least one bump disposed adjacent to one of said opposing edges defining a first side bump.

7. The fish measurement device as recited in claim 6, further including a bump disposed adjacent to the other of said opposing edges defining a second side bump.

8. The fish measurement device as recited in claim 5, wherein said side bump is formed with a plurality of teeth adjacent one edge of said substrate.

9. The fish measurement device as recited in claim 1, wherein said substrate and said at least one bump are integrally formed.

10. The fish measurement device as recited in claim 1, wherein said substrate and said at least one bump are formed from an elastomeric material.

11. The fish measurement device as recited in claim 1, wherein said elastomeric material is a synthetic rubber.

12. The fish measurement device as recited in claim 1, wherein said elastomeric material is a silicone rubber.

13. The fish measurement device as recited in claim 1, further including at least one strap for securing said fish measurement device in a rolled up position.

14. The fish measurement device as recited in claim 1, further including runners formed adjacent opposing edges for containing fish residue.
